(19) United States
(12) Patent Application Publication
(10) Pub. No.: US 2014/0286750 A1
(43) Pub. Date: Sep. 25, 2014

(54) VARIABLE TURBINE/COMPRESSOR GEOMETRY

(71) Applicants: Jochen Laubender, Markgroeningen (DE); Jens Kreth, Oberriexingen (DE)

(72) Inventors: Jochen Laubender, Markgroeningen (DE); Jens Kreth, Oberriexingen (DE)

(73) Assignee: Bosch Mahle Turbo Systems GmbH & Co. KG, Stuttgart (DE)

(21) Appl. No.: 14/117,370

(22) PCT Filed: Mar. 2, 2012
(86) PCT No.: PCT/EP2012/053608

§ 371 Date: Jun. 9, 2014

(30) Foreign Application Priority Data
May 13, 2011 (DE) 10 2011 075 794.5

(51) Int. Cl. F02B 37/24

(52) U.S. Cl. CPC F02B 37/24
USPC 415/115

(57) ABSTRACT

A variable turbine/compressor geometry for an exhaust gas turbocharger of an internal combustion engine includes a blade bearing ring having guide blades rotatably mounted therein and a cover disc which is arranged on the face end of the guide blades. At least one gas guide channel may run through at least one guide blade. The gas guide channel including, adjacent to a profile lug, a least one inlet opening, and on at least one of a face end directed towards the cover disc and a bottom side directed towards the blade bearing ring includes an outlet opening. The gas guide channel may be configured to generate a friction-reducing air cushion during operation on at least one of the face end and the bottom side.

### CROSS-REFERENCE TO RELATED APPLICATIONS

This application claims priority to German Patent Application No. 10 2011 075 794.5 filed May 13, 2011, and International Patent Application No. PCT/EP2012/053608 filed Mar. 2, 2012, both of which are hereby incorporated by reference in their entirety.

### TECHNICAL FIELD

The present invention relates to a variable turbine/compressor geometry, in particular for an exhaust gas turbocharger of an internal combustion engine, according to the preamble of claim 1. The invention additionally relates to a charging device having such a variable turbine/compressor geometry and a guide blade equipped for this.

### BACKGROUND

Charging devices are devices for increasing the power of internal combustion engines in particular in motor vehicles of modern design, wherein in a charging device designed as an exhaust gas turbocharger exhaust gas of the internal combustion engine drives a turbine of the charging device and via the latter rotates a compressor wheel, so that the compressor can feed compressed charge air to the internal combustion engine. To regulate the power of such charging devices, a variable turbine/compressor geometry is often employed, which controls or regulates for example an exhaust gas inflow to the turbine via a change of the position of the individual guide blades.

In known variable turbine/compressor geometries, which usually comprise guide blades which are rotatably mounted in a blade bearing ring, friction forces between the guide blades and the blade bearing ring or between the guide blades and a cover disc covering these occur due to axial forces acting on the guide blades. The friction forces that occur there not only lead to a higher hysteresis and thus a more difficult control behaviour of the exhaust gas turbocharger, but additionally impair the lifespan of the variable turbine/compressor geometry.

A generic variable turbine/geometry is known for example from EP 1 303 683 B1.

### SUMMARY

The present invention therefore deals with the problem of stating an improved or at least an alternative embodiment for a variable turbine/compressor geometry of the generic type, which is characterized in particular by an improved control behaviour and an increased lifespan.

According to the invention, this problem is solved through the subjects of the independent claims. Advantageous embodiments are subject of the dependent claims.

The present invention is based on the general idea of providing a gas cushion, i.e. air cushion for axially mounting guide blades in a blade bearing ring, which at least reduces any friction between the guide blades and the blade bearing ring and/or between the guide blades and a cover disc covering these. Here, the cover disc is arranged at the face end of the guide blades. According to the invention, at least one gas guide channel runs through at least one guide blade, which gas guide channel comprises at least one inlet opening in the region of a profile lug and an outlet opening on the face end directed to the cover disc or at the bottom side directed towards the blade bearing ring and because of this generates a gas cushion, in particular an air cushion reducing the friction on the face end and/or on the bottom side during the operation of the variable turbine/compressor geometry, i.e. during an onflow of the guide blades. During the operation of the variable turbine/compressor geometry, the guide blades are thus subjected to an onflow via the profile lug, wherein a part of the onflowing gas enters the at least one inlet opening and is directed to the associated outlet opening through the gas guide channel, in order to generate the friction-reducing (air) cushion between the guide blade and the blade bearing ring or the cover disc there. With the guide blade according to the invention it is thus possible to achieve a floating mounting of the individual guide blades in a particularly simple but effective design manner, as a result of which the hysteresis behaviour known from the variable turbine/compressor geometries known from the prior art up to now can be almost eliminated and additionally the lifespan of the variable turbine/compressor geometry significantly increased.

In an advantageous further development of the solution according to the invention, at least one of the guide blades comprises two gas guide channels, of which one leads to the outlet opening arranged on the face end and the other one to the outlet opening arranged on the bottom side of the guide blade. Through the two gas guide channels, both an air mounting of the guide blades with respect to the blade bearing ring as well as with respect to the cover disc is thus possible, as a result of which the friction of the guide blade in the region of the cover disc as well as in the region of the blade bearing ring can be reduced, preferentially even entirely eliminated. Here it is obviously conceivable that the two gas guide channels have a common or two separate inlet openings, wherein in the first case the gas guide channels are fed by a common inlet opening.

Practically, at least one guide blade has a pocket-shaped and rimmed recess on its face end and/or on its bottom side, which limits the air cushion. The pocket-shaped recess thus provides a receiving space for the gas flowing out of the outlet opening and a collecting space for the same, wherein flowing-out of the gas from this collecting space can merely take place via the rim, so that the guide blades with respect to the cover disc or the blade bearing ring flowed similar to a air-cushion vehicle and because of this preferentially do not come in contact with the latter.

In a further advantageous embodiment of the solution according to the invention, the gas guide channels and/or the recesses are produced on the guide blades by means of milling, eroding, lasering, drilling or etching. Even the counting of the aforementioned production methods gives an idea of the variety of the production possibilities, wherein the choice of the individual production method is to be made according to design or production or economic considerations. All of the mentioned production methods make possible an extremely exact and additionally cost-effective production of the relevant recesses or the relevant gas guide channels, as a result of which a high-quality production on the one hand and a cost-effective production of the guide blades on the other hand is made possible.

In a further advantageous embodiment of the solution according to the invention, at least one of the guide blades is produced by means of as forging method, casting method, sintering method, MIM (metal injection moulding). The MIM method in this case is a sub-method of the powder injection moulding method, in which a metal powder provided with a binder is processed in an injection moulding process. The binder is subsequently removed, as a result of which it becomes possible to produce parts of complex shape in larger quantities with extremely small production tolerances.

Further important features and advantages of the invention are obtained from the subclaims, from the drawings and from the associated Figure description by means of the drawing.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference characters relate to same or similar or functionally same components.

### BRIEF DESCRIPTION OF THE DRAWINGS

Here it shows, in each case schematically:

FIG. 1a a view of a variable turbine/compressor geometry according to the invention with a guide blade according to the invention,

FIG. 1b a view of a further possible embodiment of the guide blade according to the invention,

FIG. 2 a representation as in FIG. 1, however from another view.

### DETAILED DESCRIPTION

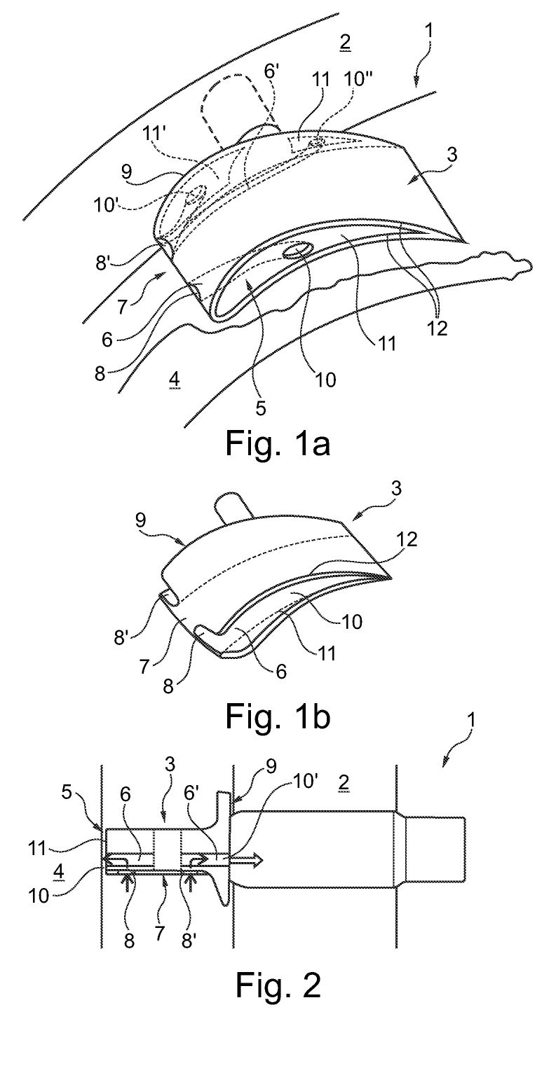

According to FIGS. 1 and 2, a variable turbine/compressor geometry 1 according to the invention comprises a blade bearing ring 2 in particular for an exhaust gas turbocharger of an internal combustion engine, preferentially in a motor vehicle, with guide blades 3 mounted therein. At the face end of the guide blades 3, a cover disc 4 is arranged here, which according to FIG. 1 is merely shown partially in order to be able to better represent in particular a face end 5 of the guide blade 3 directed towards the cover disc 4. According to the invention, at least one gas guide channel 6, which in principle can be designed as an air guide channel, now runs through at least one guide blade 3, which air guide channel in the region of a profile lug 7 comprises at least one inlet opening 8, 8′ and on the face end 5 orientated towards the cover disc 4 and/or on a bottom side 9 directed towards the blade bearing ring 2 comprises an outlet opening 10, 10′, 10″ and because of this generates a friction-reducing gas cushion on the face end 5 and/or on the bottom side 9.

Obviously, a guide blade 3 according to the invention, as is shown according to FIG. 1, can also comprise two separate gas guide channels 6, 6′, of which one gas guide channel 6 leads to the outlet opening 10 arranged on the face end 5 and the other gas guide channel 6′ leads to the outlet opening 10′, 10″ arranged on the bottom side 9. The two gas guide channels 6, 6′ in this case can comprise a common inlet opening as is shown according to FIG. 1, or two separate inlet openings 8, 8′, which also extend over the entire width of the profile lug 7 of the guide blade 3. In particular, this can mean that a rim 12 of a pocket-shaped recess 11, 11′ can be interrupted at this point.

Viewing in particular Figure la, it is evident that the guide blade 3 on its face end 5 and on its bottom side 9 comprises a pocket-shaped and rimmed recess 11, 11′, which limits the air cushion that develops during the operation of the variable turbine/compressor geometry 1. On the bottom side 9 of the guide blade 3, two recesses 11 and 11′ which are separated from one another are provided, which are both air or gas-supplied from the gas guide channel 6′. Obviously, the two recesses 11, 11′ can also be formed continuously in this case. The pocket-shaped recess 11, 11′ can extend over the entire length of the guide blades 3 or only of a part thereof

In FIG. 1b, a guide blade is shown, in which the inlet openings 8, 8′ are open towards the face end 5 or towards the bottom side 9. In such a guide blade 3, the gas guide channel 6, 6′ as well as the outlet openings 10, 10′ are formed by the recess 11, 11′ at the same time. In this case, the inlet openings 8, 8′ break through the rim 12 of the recess 11, 11′. The gas guide channel 6, 6′ in this case is designed as an open channel.

The gas guide channels 6, 6′ and/or the recess 11, 11′ can for example be produced by means of milling, eroding, lasering, drilling or etching, wherein all listed production methods already give an idea of how flexible a production process can be selected. The at least one inlet opening 8, 8′ as well as the associated outlet openings 10, 10′, 10″ can have an angular cross section (see FIG. 2) or an elliptical or round cross section. The guide blade 3 can be produced for example by means of a forging method, a casting method, a sintering method or a powder injection moulding method, in particular a metal injection moulding method (MIM).

With the guide blade 3 according to the invention it is possible during the operation to generate a gas cushion (air cushion) which flows out of the face end 5 and/or of the bottom side 9, which mounts the guide blade 3 on an air cushion with respect to the blade bearing ring 2 and with respect to the cover disc 4 and because of this stops any direct contact between guide blade 3 and blade bearing ring 2 or cover disc 4. The air mounting in this case reduces in particular a hysteresis behaviour which occurs and additionally increases the lifespan significantly.

1. A variable turbine/compressor geometry for an exhaust gas turbocharger of an internal combustion engine, comprising: a blade bearing ring having guide blades rotatably mounted therein and a cover disc which is arranged on the face end of the guide blades,
at least one gas guide channel running through at least one guide blade, the gas guide channel including, adjacent to a profile lug, at least one inlet opening, and on at least one of a face end directed towards the cover disc and a bottom side directed towards the blade bearing ring includes an outlet opening, the gas guide channel configured to generate a friction-reducing air cushion during operation on at least one of the face end and the bottom side.

2. The variable turbine/compressor geometry according to claim 1,
wherein at least one guide blade includes at least two gas guide channels, one of which leads to the outlet opening arranged on the face end and the other one to an outlet opening arranged on the bottom side.

3. The variable turbine/compressor geometry according to claim 2,
wherein the two gas guide channels have one of a common inlet opening and two separate inlet openings.

4. The variable turbine/compressor geometry according to claim 1,
wherein at least one guide blade on at least one of its face end and its bottom side includes at least one pocket-shaped and rimmed recess, which limits the gas cushion.

5. The variable turbine/compressor geometry according to claim 4, wherein at least one of the gas guide channels and the recess is formed via at least one of milling, eroding, lasering, drilling and etching.

6. The variable turbine/compressor geometry according to claim 1,
wherein the at least one inlet opening has at least one of an angular, an elliptical and a round cross-section.

7. The variable turbine/compressor geometry according to any one of the claim 1, wherein at least one guide blade is produced by at least one of forging, casting, sintering, and MIM (metal injection moulding).

8. The variable turbine/compressor geometry according to claim 4,
wherein the pocket-shaped recess extends at least partially over the length of the guide blade.

9. (canceled)

10. A guide blade for a variable turbine/compressor geometry,. comprising:
at least one gas guide channel running through the guide blade, the gas guide channel having at least one inlet opening adjacent to a profile lug and an outlet opening on at least one of a face end and a bottom side located opposite thereof, the gas guide channel configured to generate a friction-reducing air cushion during operation on at least one of the face end and the bottom side, respectively.

11. The variable turbine/compressor geometry according to claim 1, wherein at least one guide blade includes at least one pocket-shaped and rimmed recess on its face end and on its bottom side.

12. The variable turbine/compressor geometry according to claim 11, wherein the gas guide channels and the recess are formed via one of milling, eroding, lasering, drilling, and etching.

13. The variable turbine/compressor geometry according to claim 11, wherein the pocket-shaped recess extends at least partially over the length of the guide blade.

14. The variable turbine/compressor geometry according to claim 1, wherein the gas guide channel is formed via one of milling, eroding, lasering, drilling, and etching.

15. The variable turbine/compressor geometry according to claim 2, wherein the at least two inlet openings have one of an angular, elliptical, and round cross-section.

16. The guide blade according to claim 10, further comprising a second gas guide channel, one of which leads to the outlet opening arranged on the face end and the other leading to an outlet opening arranged on the bottom side.

17. The guide blade according to claim 16, wherein the two gas guide channels have one of a common inlet opening and two separate inlet openings.

18. The guide blade according to claim 10, wherein at least one inlet opening has one of an angular, elliptical, and round cross-section.

19. The guide blade according to claim 10, further comprising at least one pocket-shaped and rimmed recess arranged on at least one of the face end and the bottom side.

20. The guide blade according to claim 19, wherein the at least one pocket-shaped recess extends at least partially over the length of the guide blade.

21. The guide blade according to claim 19, wherein at least one of the gas guide channel and the recess is formed via one of milling, eroding, lasering, drilling, and etching.
